(19) United States
(12) Patent Application Publication
(10) Pub. No.: US 2003/0048768 A1
(43) Pub. Date: Mar. 13, 2003

(54) Information device with wireless modules

(75) Inventors: Norimasa Nakamura, Iruma-shi (JP); Toru Hanada, Ome-shi (JP); Takeshi Tajima, Hamura-shi (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 10/101,757

(22) Filed: Mar. 21, 2002

(30) Foreign Application Priority Data
Sep. 11, 2001 (JP) 2001-275497

(51) Int. Cl. H04Q 7/24; H04J 3/24

(52) U.S. Cl. 370/338; 370/349

(57) ABSTRACT

This invention provides an information device which disenables unselected wireless devices by directly controlling hardware, and thus can prevent interference between wireless devices using the same frequency band. In this invention, a BIOS controls an EC for a wireless module selected based on a user instruction, thereby controlling power supply to a Bluetooth module and power supply to a wireless LAN module. This makes it possible to enable either one of the modules and disenable the other module.

### CROSS-REFERENCE TO RELATED APPLICATIONS

This application is based upon and claims the benefit of priority from the prior Japanese Patent Application No. 2001-275497, filed Sep. 11, 2001, the entire contents of which are incorporated herein by reference.

### BACKGROUND OF THE INVENTION

1. Field of the Invention

The present invention relates to an information device having two or more wireless modules and, more particularly, to use control of these wireless modules.

2. Description of the Related Art

Personal computers having a plurality of wireless devices have recently been developed along with the development of the wireless communication technology. An example of the personal computer has a Bluetooth module using a 2.4-GHz ISM (Industrial Scientific Medical) band and a wireless LAN module based on IEEE 802.11b.

This personal computer can perform wireless communication using the Bluetooth module and wireless communication using the wireless LAN module.

If, however, a plurality of wireless functions simultaneously operate, they interfere with each other to decrease the communication speed because they use the same 2.4-GHz ISM band.

In this case, the user may select a wireless device at the application level. Merely selecting a wireless device at the application level cannot prevent simultaneous use of a plurality of wireless device by user operation. A personal computer which incorporates two wireless devices in a single housing cannot meet the wireless standards of some areas that inhibit a plurality of wireless devices from simultaneously operating. It is difficult for the user to determine the radio frequency band used in a wireless module incorporated in an information device. Further, the user must have advanced knowledge to switch and use a plurality of wireless modules.

### BRIEF SUMMARY OF THE INVENTION

The present invention has been made in consideration of the above situation, and has as its object to provide an information device which disenables unselected wireless devices by directly controlling hardware, and thus can prevent a plurality of wireless modules from simultaneously operating.

It is another object of the present invention to provide an information device which enables one wireless device, disenables another wireless device, and thus can meet the wireless standards of some areas that inhibit a plurality of wireless devices from simultaneously operating in a personal computer which incorporates two wireless devices in a single housing.

To achieve the above objects, according to a first aspect of the invention, there is provided an information device comprising a first wireless module which performs wireless communication in accordance with a first communication way, a second wireless module which performs wireless communication in accordance with a second communication way, means which can select either one of the first and second wireless modules, and a control unit which, when the first wireless module is selected by the selection means, disenables wireless communication via the second wireless module and then enables the first wireless module, and when the second wireless module is selected, disenables wireless communication via the first wireless module and then enables the second wireless module.

According to a second aspect of the invention, there is provided an information device comprising a Bluetooth wireless module which performs wireless communication in accordance with a Bluetooth standard, a wireless LAN unit which performs wireless communication in accordance with an IEEE 802.1b standard, a first utility which determines a selected wireless module on the basis of a user instruction, and when the selected wireless module is determined as the Bluetooth wireless module, instructs to power off the wireless LAN unit, a second utility which instructs to turn on the Bluetooth wireless module on the basis of the instruction from the first utility that represents power off of the wireless LAN unit, a BIOS which instructs to power off the wireless LAN unit on the basis of the instruction from the first utility, and instructs to power on the Bluetooth wireless module on the basis of the instruction from the second utility, and a controller which controls to stop power supply to the wireless LAN unit on the basis of the instruction from the BIOS that represents power off of the wireless LAN unit, and which, upon receiving the instruction from the BIOS that represents power on of the Bluetooth wireless module, controls to supply power to the Bluetooth wireless module after the wireless LAN unit is powered off.

### BRIEF DESCRIPTION OF THE SEVERAL VIEWS OF THE DRAWING

FIG. 1 is a block diagram showing the hardware arrangement of a notebook type personal computer according to an embodiment of the present invention;

FIG. 2 is a block diagram showing the relationship between an OS, a BIOS, and an EC;

FIG. 3 is a block diagram showing the relationship between the OS, the BIOS, and the EC;

FIG. 4 is a flow chart for explaining the operation of the notebook type personal computer according to the embodiment of the present invention;

FIG. 5 is a flow chart for explaining the operation of the notebook type personal computer according to the embodiment of the present invention; and

FIG. 6 is a flow chart for explaining the operation of the notebook type personal computer according to the embodiment of the present invention.

### DETAILED DESCRIPTION OF THE INVENTION

A notebook type personal computer according to an embodiment of the present invention will be described below with reference to the several views of the accompanying drawing.

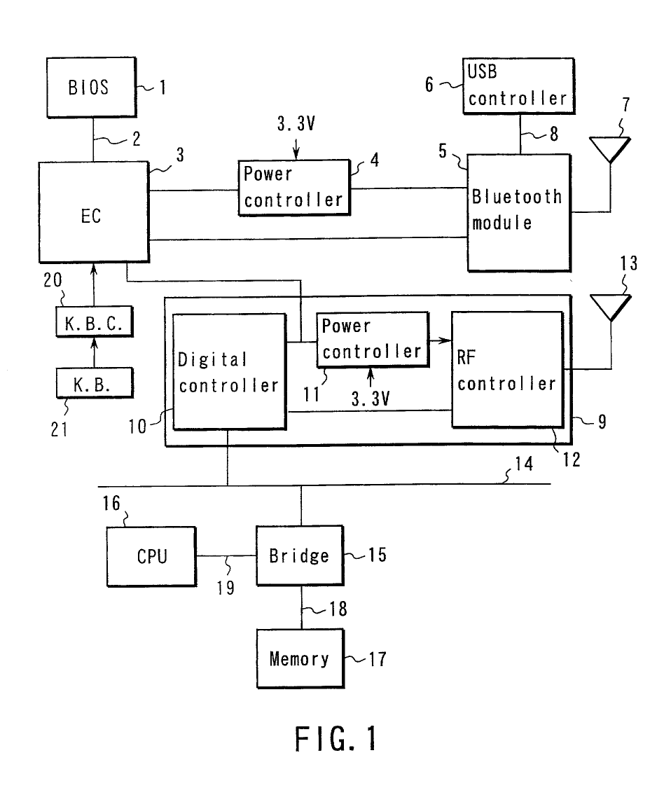

FIG. 1 is a block diagram showing the hardware arrangement of the notebook type personal computer according to the embodiment of the present invention.

In FIG. 1, a BIOS 1 executes the basic control of the personal computer and serves as an interface with an application program. The BIOS 1 is connected to an EC (Embedded Controller) 3 via an I2C bus 2, and issues a command to the EC 3 to control it.

The EC 3 is a one-chip microcomputer which interprets a command issued from the BIOS 1 and controls power supply and control signals to various devices within the personal computer.

More specifically, the EC 3 controls a power controller 4 to control power supply to a Bluetooth module 5.

The EC 3 controls the Bluetooth module 5 to electrically connect/disconnect a USB bus 8 between the Bluetooth module 5 and a USB controller 6. The EC 3 outputs a control signal to control a power controller 11 of a wireless LAN module 9 and control power supply to an RF controller 12. The control signal output from the EC 3 to the power controller 11 undergoes logical operation with a signal output from a digital controller 10, and the logical operation result serves as a control signal to the power controller 11.

The power controller 4 supplies a power of 3.3 V to the Bluetooth module 5 on the basis of a control signal from the EC 3.

The Bluetooth module 5 communicates with the USB controller 6 via the USB bus 8, and uses an antenna 7 to perform wireless communication based on the Bluetooth standard. The Bluetooth module 5 has a function of stopping Bluetooth operation and radiation of wireless radio waves when it is electrically disconnected from the USB controller 6.

The USB controller 6 is connected to the Bluetooth module 5 via the USB bus 8, and controls the Bluetooth module 5.

The wireless LAN module 9 is connected to the EC 3, executes wireless communication based on IEEE 802.11b, and comprises the digital controller 10, power controller 11, and RF controller 12. The wireless LAN module 9 communicates with the system via a PCI bus 14.

The digital controller 10 is connected to the PCI bus 14, and controls the digital part of the wireless LAN module 9 and the RF controller 12. The digital controller 10 outputs a control signal to the power controller 11.

The power controller 11 controls supply of a 3.3-V power to the RF controller 12 on the basis of control signals from the digital controller 10 and EC 3.

The RF controller 12 controls the wireless part of the wireless LAN module 9, and performs wireless communication using an antenna 13 on the basis of the IEEE 802.1b standard.

A bridge 15 is connected to the PCI bus 14, to a CPU 16 via a CPU bus 19, and to a memory 17 via a memory bus 18. The bridge 15 executes bus bridge control.

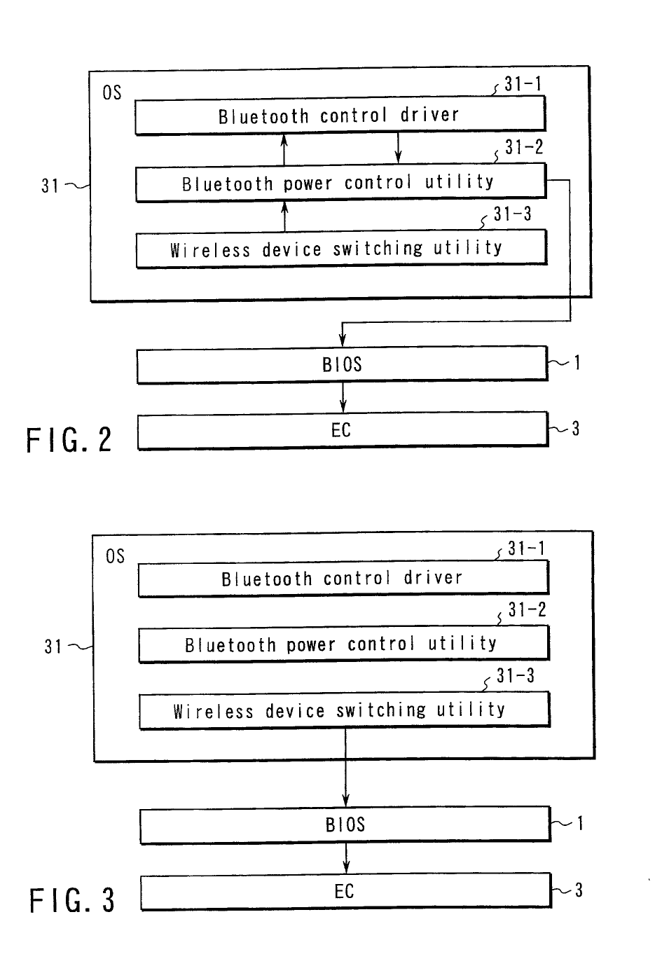

The CPU 16 controls the entire system. As shown in FIG. 2, the memory 17 stores a Bluetooth control driver 31-1, Bluetooth power control utility 31-2, and wireless device switching utility 31-3 included in an OS used in the personal computer of this embodiment.

The EC 3 is connected to a keyboard 21 serving as a user interface via a keyboard controller 20.

The Bluetooth control driver 31-1 controls the Bluetooth module 5.

The Bluetooth power control utility 31-2 controls power supply to the Bluetooth module 5.

The wireless device switching utility 31-3 is a program for selecting a wireless device by using a prescribed key combination such as a hot key.

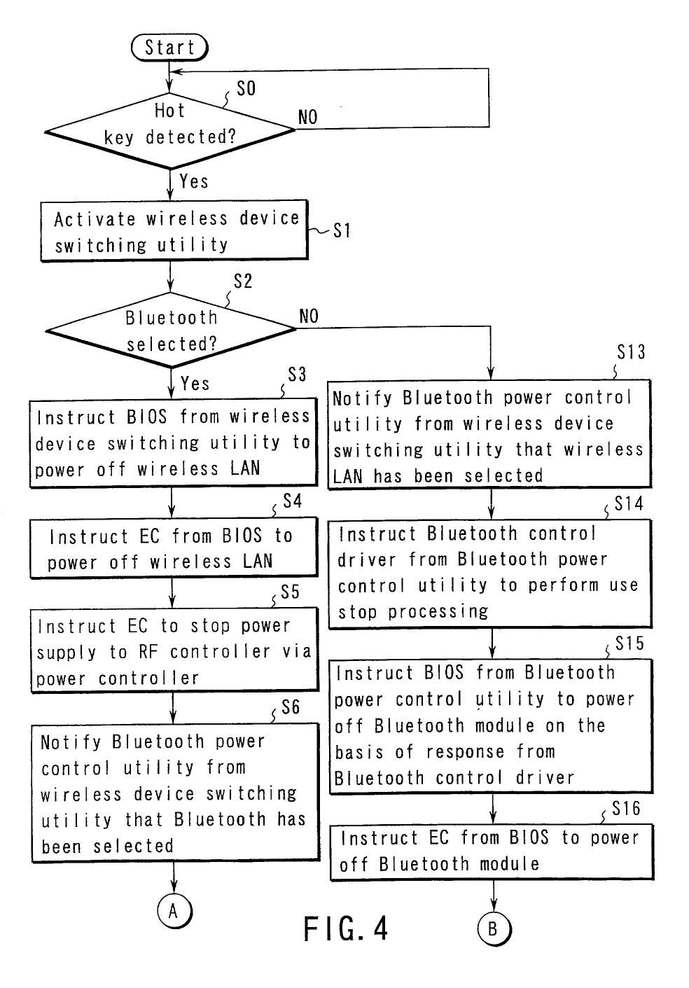

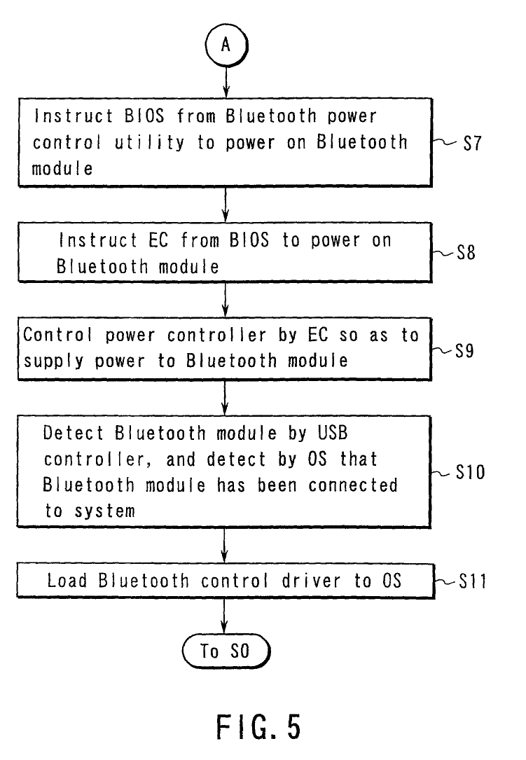

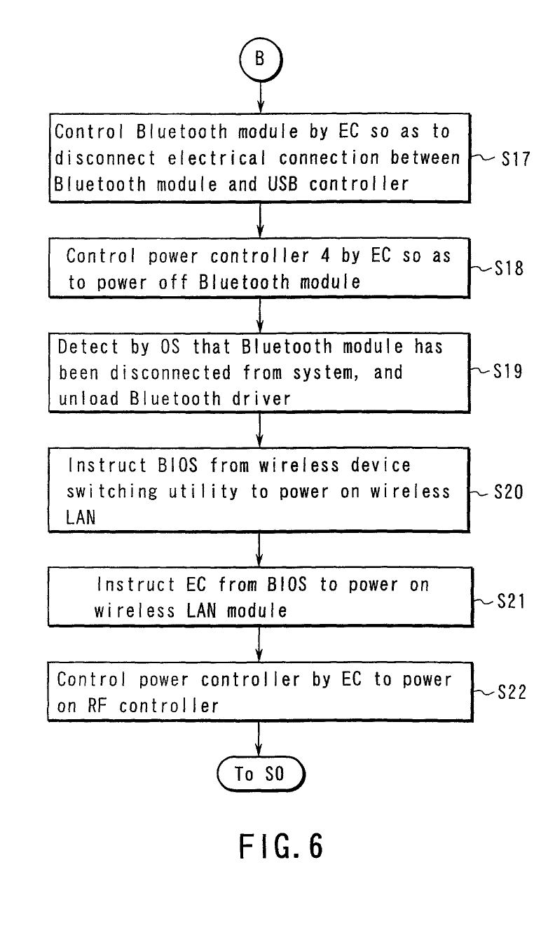

The operation of the notebook type personal computer according to the embodiment will be described with reference to the block diagrams of FIGS. 2 and 3 showing the relationship between the OS, the BIOS, and the EC, and the flow charts of FIGS. 4 to 6.

If a hot key which realizes a specific function is input by a predetermined key combination through the keyboard 21 and the BIOS detects the hot key (YES in S0), the wireless device switching utility 31-3 is activated (S1). The wireless device switching utility 31-3 checks whether Bluetooth is selected (S2).

If YES in S2, the wireless device switching utility 31-3 instructs the BIOS 1 to power off the wireless LAN (S3: see FIG. 3).

Having received the instruction from the wireless device switching utility 31-3, the BIOS 1 instructs the EC 3 to power off the wireless LAN (S4: see FIG. 3).

Having received the instruction from the BIOS 1, the EC 3 controls to stop power supply to the RF controller 12 via the power controller 11 (S5). Then, radiation of radio waves from the wireless LAN module 9 stops.

The wireless device switching utility 31-3 notifies the Bluetooth power control utility 31-2 that Bluetooth has been selected (S6: see FIG. 2). Having received the notification from the wireless device switching utility 31-3, the Bluetooth power control utility 31-2 instructs the BIOS 1 to power on the Bluetooth module 5 (S7: see FIG. 2).

The BIOS 1 instructs the EC 3 to power on the Bluetooth module 5 (S8: see FIG. 2). Then, the EC 3 controls the power controller 4 so as to supply power to the Bluetooth module 5 (S9).

After the Bluetooth module 5 is powered on, the USB controller 6 detects the Bluetooth module 5, and the OS 31 detects that the wireless LAN module 9 has been connected to the system (S10).

The Bluetooth control driver 31-1 is loaded to the OS 31 (S11), and the flow shifts to processing in S0.

If NO in S2, the wireless device switching utility 31-3 notifies the Bluetooth power control utility 31-2 that the wireless LAN has been selected (S13: see FIG. 2).

The Bluetooth power control utility 31-2 instructs the Bluetooth control driver 31-1 to perform use stop processing (S14: see FIG. 2).

Based on a response from the Bluetooth control driver 31-1, the Bluetooth power control utility 31-2 instructs the BIOS 1 to power off the Bluetooth module 5 (Sl5).

The BIOS 1 instructs the EC 3 to power off the Bluetooth module 5 (S16). When the EC 3 is instructed by the BIOS 1 to power off the wireless LAN module 9, it controls the Bluetooth module 5 so as to electrically disconnect the Bluetooth module 5 and USB controller 6 (S17).

After the Bluetooth module 5 is electrically disconnected from the USB controller 6, the EC 3 controls the power controller 4 so as to stop power supply to the Bluetooth module 5 (S18).

After power supply to the Bluetooth module 5 stops, the OS 31 detects that the Bluetooth module 5 has been disconnected from the system, and unloads the Bluetooth control driver 31-1 (S19). Then, radiation of radio waves from the Bluetooth module 5 via the antenna 7 stops.

After the wireless LAN module is powered off and radiation of radio waves from the wireless LAN module is completely inhibited, the wireless device switching utility 31-3 instructs the BIOS 1 to power on the wireless LAN (S20). Upon being instructed by the wireless device switching utility 31-3 to power on the wireless LAN, the BIOS 1 instructs the EC 3 to power on the wireless LAN module 9 (S21).

The EC 3 controls the power controller 11 to supply power to the RF controller 12 (S22). Then, the wireless LAN module 9 radiates radio waves via the antenna 13.

The notebook type personal computer according to the embodiment can activate a wireless device switching utility by using a hot key which realizes a specific function with a key combination instructed by the user in advance, and can easily select a wireless device to be used. The interference between wireless devices using the same frequency can be prevented.

A notebook type personal computer which incorporates a plurality of wireless devices in a single housing can meet the wireless standards of some areas that inhibit a plurality of wireless devices from simultaneously operating.

Although the embodiment has exemplified IEEE 802.11b and Bluetooth, the present invention can also be applied to another wireless communication standard of emitting radio waves, such as IEEE 802.11a or HomeRF.

The present invention is not limited to the above embodiment, and can be variously modified without departing from the spirit and scope of the present invention in practical use.

As has been described above, the present invention can provide an information device which enables one wireless device, disenables another wireless device, and thus can meet the wireless standards of some areas that inhibit a plurality of wireless devices from simultaneously operating in a personal computer which incorporates a plurality of wireless devices in a single housing.

What is claimed is:

1. An information device comprising:
a first wireless module which performs wireless communication in accordance with a first communication way;
a second wireless module which performs wireless communication in accordance with a second communication way;
means which selects either one of said first and second wireless modules; and
a control unit which, when said first wireless module is selected by said selection means, disenables wireless communication via said second wireless module and then enables said first wireless module, and when said second wireless module is selected, disenables wireless communication via said first wireless module and then enables said second wireless module.

2. A device according to claim 1, wherein the first communication way includes a communication way based on a Bluetooth standard, and the second communication way includes a communication way based on an IEEE 802.1b standard.

3. A device according to claim 1, wherein said first and second wireless modules are powered off when wireless communication via said first and second wireless modules is disenabled.

4. An information device comprising:
a Bluetooth wireless module which performs wireless communication in accordance with a Bluetooth standard;
a wireless LAN unit which performs wireless communication in accordance with an IEEE 802.1b standard;
a first utility which determines a selected wireless module on the basis of a user instruction, and when the selected wireless module is determined as said Bluetooth wireless module, instructs to power off said wireless LAN unit;
a second utility which instructs to turn on said Bluetooth wireless module on the basis of the instruction from said first utility that represents power off of said wireless LAN unit;
a BIOS which instructs to power off said wireless LAN unit on the basis of the instruction from said first utility, and instructs to power on said Bluetooth wireless module on the basis of the instruction from said second utility; and
a controller which controls to stop power supply to said wireless LAN unit on the basis of the instruction from said BIOS that represents power off of said wireless LAN unit, and which, upon receiving the instruction from said BIOS that represents power on of said Bluetooth wireless module, controls to supply power to said Bluetooth wireless module after said wireless LAN unit is powered off.

5. A device according to claim 4, further comprising means for loading a control driver of said Bluetooth wireless module to an operating system when said Bluetooth wireless module receives power.

6. A device according to claim 4, wherein
when the selected wireless module is determined as said wireless LAN unit, said first utility notifies said second utility that said wireless LAN has been selected,
said second utility instructs said BIOS to power off said Bluetooth wireless module on the basis of the notification from said first utility that said wireless LAN has been selected,
said BIOS instructs said controller to power off said Bluetooth wireless module on the basis of the instruction from said second utility that represents power off of said Bluetooth wireless module, and
said controller powers off said Bluetooth wireless module on the basis of the instruction from said BIOS that represents power off of said Bluetooth wireless module.

7. A device according to claim 6, further comprising means for unloading a driver of said Bluetooth wireless module when said Bluetooth wireless module is powered off.

8. A device according to claim 7, wherein
when the driver of said Bluetooth wireless module is unloaded, said first utility instructs said BIOS to power on said wireless LAN unit,
said BIOS instructs said controller to power on said wireless LAN unit on the basis of the instruction from said first utility that represents power on of said wireless LAN unit, and
said controller controls to supply power to the RF controller of said wireless LAN unit on the basis of the instruction from said BIOS that represents power on of said wireless LAN unit.

9. A device according to claim 4, wherein said controller includes a one-chip microcomputer.

10. A device according to claim 4, wherein said first and second wireless modules use a wireless frequency band in which said first and second wireless modules interfere with each other.

11. A wireless module switching method in an information device having a first wireless module which performs wireless communication in accordance with a first communication way, and a second wireless module which performs wireless communication in accordance with a second communication way, comprising:
determining based on a user instruction whether a selected wireless module is the first wireless module; and
when the selected wireless module is determined as the first wireless module, enabling the first wireless module and disenabling the second wireless module, and when the selected wireless module is not determined as the first wireless module, disenabling the first wireless module and enabling the second wireless module.

12. An information device comprising:
a first wireless module which performs wireless communication in accordance with a first communication way;
a second wireless module which performs wireless communication in accordance with a second communication way;
means which can select either one of said first and second wireless modules;
a BIOS which, when said first wireless module is selected by said selection means, instructs to stop power supply to said second wireless module and then instructs to supply power to said first wireless module, and when said second wireless module is selected by said selection means, instructs to stop power supply to said first wireless module and then instructs to supply power to said second wireless module; and
a controller which powers off either one of said first and second wireless modules and then powers on the other one of said first and second wireless modules on the basis of an instruction from said BIOS.

13. A wireless module switching method in an information device having a first wireless module which performs wireless communication in accordance with a first communication way, and a second wireless module which performs wireless communication in accordance with a second communication way, comprising:
determining which of the first and second wireless modules has been selected, and notifying a BIOS of the information device of a determination result from selection means;
causing the BIOS to instruct to stop power supply to the second wireless module and then instruct to supply power to the first wireless module in accordance with a notification that the first wireless module has been selected, and to instruct to stop power supply to the first wireless module and instruct to supply power to the second wireless module in accordance with a notification that the second wireless module has been selected; and
powering on/off the first and second wireless modules on the basis of the instruction from the BIOS.
